(19) United States
(12) Patent Application Publication
(10) Pub. No.: US 2026/0249661 A1
(43) Pub. Date: Aug. 27, 2026

(54) VEHICLE SUSPENSION CONTROL SYSTEM

(71) Applicant: TOYOTA JIDOSHA KABUSHIKI KAISHA, Toyota-shi (JP)

(72) Inventor: Hiroki FURUTA, Tokyo-shi (JP)

(73) Assignee: TOYOTA JIDOSHA KABUSHIKI KAISHA, Toyota-shi (JP)

(21) Appl. No.: 19/413,095

(22) Filed: Dec. 9, 2025

(30) Foreign Application Priority Data
Feb. 27, 2025 (JP) 2025-030091

(51) Int. Cl. B60G 17/016; B60G 17/019

(52) U.S. Cl. CPC B60G 17/0164; B60G 17/01908; B60G 2400/0511; B60G 2400/0512; B60G 2800/012; B60G 2800/014

(57) ABSTRACT

A suspension control system includes an actuator that controls a suspension stroke of a control target wheel and an electronic control unit. The electronic control unit includes a requested control amount calculation unit that calculates a pitch requested control amount for pitch control. In processing of calculating the pitch requested control amount, a pitch gain used for calculating the pitch requested control amount at the time of acceleration is set to be smaller than a pitch gain used for calculating the pitch requested control amount at the time of deceleration.

### CROSS-REFERENCE TO RELATED APPLICATION

This application claims priority to Japanese Patent Application No. 2025-030091 filed on Feb. 27, 2025. The disclosure of the above-identified application, including the specification, drawings, and claims, is incorporated by reference herein in its entirety.

### BACKGROUND

### 1. Technical Field

The present disclosure relates to a vehicle suspension control system including an actuator that controls a suspension stroke.

### 2. Description of Related Art

Japanese Unexamined Patent Application Publication No. 2023-49946 (JP 2023-49946 A) discloses a vehicle suspension control device including an actuator that controls a suspension stroke of a control target wheel, and an electronic control unit. The electronic control unit executes a first calculation process of calculating a first requested control amount for ride comfort control with respect to road surface input and a second calculation process of calculating a second requested control amount for posture control with respect to vehicle operation input. When a sum of the first requested control amount and the second requested control amount exceeds a control amount range that can be output by the actuator, the electronic control unit executes an arbitration process of limiting the second requested control amount to be small based on road surface input information.

### SUMMARY

A vehicle including an actuator that controls a suspension stroke has a function of executing posture control with respect to vehicle operation input by actively controlling roll and/or pitch of a vehicle using the actuator. In such posture control, by increasing a control gain used for calculating a requested control amount for the posture control, an effect of the posture control can be enhanced and comfort of the vehicle can be improved.

On the other hand, there is an upper limit to output of the actuator, and when the requested control amount is excessively large, the requested control amount may exceed a capability of the actuator, and the actuator may be in a state in which active control cannot be performed, resulting in a decrease in comfort. In particular, in a case where turning and acceleration or deceleration are overlapped by the vehicle operation input, roll control resulting from the turning and pitch control resulting from the acceleration or deceleration are executed at the same time, and thus the requested control amount is likely to be excessively large. The present disclosure can provide a method of controlling a suspension stroke such that comfort can be maintained even in a case where roll control resulting from turning and pitch control resulting from acceleration or deceleration are executed at the same time. The present disclosure can also provide a method of suitably controlling the suspension stroke such that comfort is not decreased also in a case where the pitch control is executed without the roll control being executed.

An aspect of the present disclosure is a vehicle suspension control system including:
an actuator configured to control a suspension stroke of a control target wheel; and
an electronic control unit.
   The electronic control unit includes a requested control amount calculation unit configured to calculate a pitch requested control amount for pitch control.
   In a process of calculating the pitch requested control amount, a pitch gain used for calculating a pitch requested control amount at a time of acceleration is set to be smaller than a pitch gain used for calculating a pitch requested control amount at a time of deceleration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a vehicle according to an embodiment;

FIG. 2 is a diagram schematically showing a configuration of a suspension;

FIG. 3 is a diagram showing a functional block of a vehicle suspension control system;

FIG. 4 is a diagram showing an example of a flowchart for executing the posture control with respect to the vehicle operation input;

FIG. 5 is a diagram showing another example of the flowchart for executing the posture control with respect to the vehicle operation input;

FIG. 6A is a diagram showing an example of a relationship between a roll gain and a pitch gain; and

FIG. 6B is a diagram showing an example of the relationship between the roll gain and the pitch gain.

### DETAILED DESCRIPTION OF EMBODIMENTS

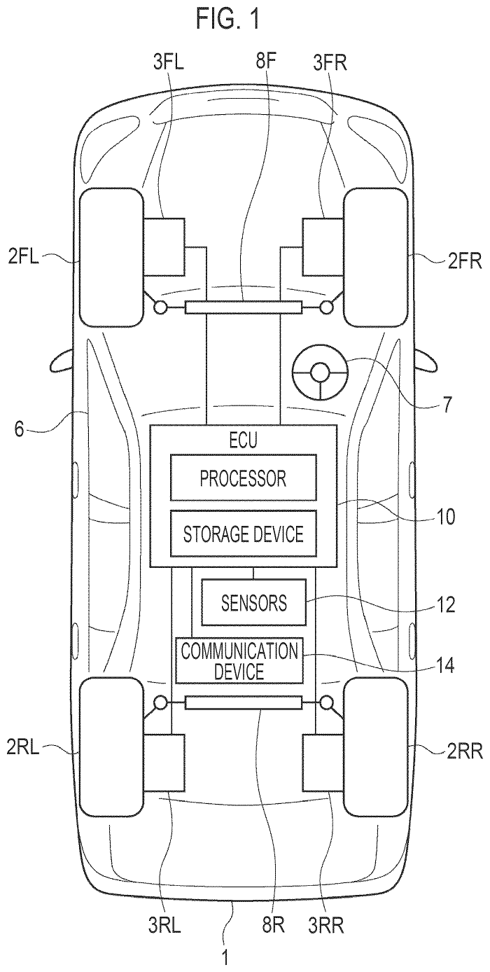

FIG. 1 schematically shows a configuration of a vehicle 1 according to the embodiment. The vehicle 1 includes a plurality of wheels and a plurality of suspensions that suspends the wheels from a vehicle body 6. The wheels include a front left wheel 2FL, a front right wheel 2FR, a rear left wheel 2RL, and a rear right wheel 2RR. The suspensions include a suspension 3FL that suspends the front left wheel 2FL, a suspension 3FR that suspends the front right wheel 2FR, a suspension 3RL that suspends the rear left wheel 2RL, and a suspension 3RR that suspends the rear right wheel 2RR. In the following, unless otherwise specified, each wheel is referred to as a wheel 2, and each suspension is referred to as a suspension 3.

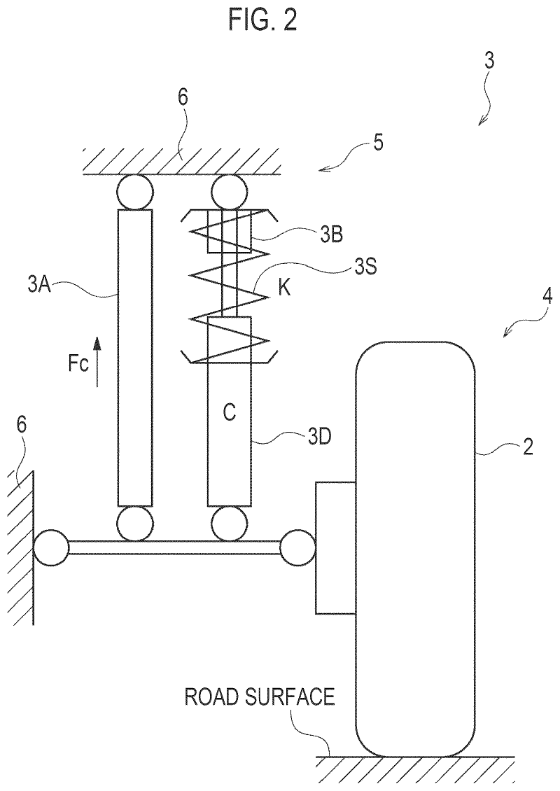

FIG. 2 schematically shows a configuration of the suspension 3. The suspension 3 is provided to connect the unsprung structure 4 including the wheels 2 and the sprung structure 5 including the vehicle body 6. The suspension 3 includes a spring 3S, a damper (shock absorber) 3D, and an actuator 3A. The spring 3S, the damper 3D, and the actuator 3A are provided in parallel between the unsprung structure 4 and the sprung structure 5. The spring constant of the spring 3S is K, and the damping coefficient of the damper 3D is C. The suspension 3 includes a bump rubber (bump stopper) 3B provided in coaxial relation to the damper 3D.

The actuator 3A controls the stroke ST of the suspension 3 by applying the control force Fc in the vertical direction between the unsprung structure 4 and the sprung structure 5. The actuator 3A may be an active actuator (so-called actuator that constitutes a full active suspension) of an electric type or a hydraulic type. The actuator 3A may be an actuator that varies a damping force generated by the damper 3D, for example, or an actuator of an active stabilizer device.

The vehicle 1 may be a vehicle of a steer-by-wire system. The steering device of the vehicle 1 includes a steering wheel 7 and turning actuators 8F, 8R (hereinafter, unless otherwise specified, referred to as “turning actuator 8”). The turning actuator 8F steers the front wheels (right and left front wheels 2FR, 2FL), and the turning actuator 8R steers the rear wheels (right and left rear wheels 2RR, 2RL). The turning actuator 8 is mechanically separated from the steering wheel 7 and is controlled by an ECU 10 described later. With the steering device of the vehicle 1, the front wheels and the rear wheels can be steered independently. The turning actuator 8 may be provided on solely one of the front wheels or the rear wheels.

The vehicle 1 may be a vehicle that uses solely an internal combustion engine as a traveling drive power source, or may be an electrified vehicle that uses an electric motor as a traveling drive power source. The electrified vehicle is, for example, a battery electric vehicle (BEV), a hybrid electric vehicle (HEV), a plug-in hybrid electric vehicle (PHEV), or a fuel cell electric vehicle (FCEV). The vehicle 1 may be a vehicle driven by a driver or may be an autonomous driving vehicle.

The vehicle 1 includes an electronic control unit (ECU) 10 having a processor, a storage device, and an input and output interface. The input and output interface receives a sensor signal from the sensors 12 provided in the vehicle 1 and outputs a control signal to the actuator 3A of the suspension 3. The storage device stores various control programs for controlling the actuator 3A of the suspension 3. The processor reads and executes a control program from the storage device, and thus the active suspension control using the actuator 3A is realized. The vehicle 1 includes a communication device 14, and the ECU 10 communicates with the outside of the vehicle 1 via the communication device 14.

The sensors 12 may include an acceleration sensor that detects a lateral acceleration LA and a front-rear acceleration FA acting on the vehicle 1, and a sprung acceleration sensor that detects an up-down acceleration of the sprung structure 5. The sensors 12 may further include a suspension stroke sensor and a wheel speed sensor provided in each wheel 2. The sensors 12 may include a steering angle sensor, a turning angle sensor, a yaw rate sensor, a roll rate sensor, and the like. The sensors 12 may include an accelerator position sensor and a brake position sensor that respectively detect an amount of depression of an accelerator pedal and a brake pedal. The sensors 12 may include a position sensor that detects a position and an orientation of the vehicle 1, and the position sensor may include, for example, a global navigation satellite system (GNSS) receiver.

The ECU 10 of the embodiment has a function of executing the posture control with respect to the vehicle operation input. The posture control in the embodiment includes the roll control at the time of the turning accompanying the steering of the vehicle 1 and the pitch control accompanying the acceleration or the deceleration of the vehicle 1. In the embodiment, a case where the roll control and the pitch control are executed at the same time will be described.

The roll control in the embodiment is to control the suspension stroke ST by applying the control force Fc to cancel the roll that occurs during the turning accompanying the steering of the vehicle 1, and to generate the reverse roll moment. Here, “canceling the roll” refers to suppressing the generated roll or generating the roll in a direction opposite to the generated roll as compared with a case where the roll control is not executed.

The pitch control in the embodiment is to control the suspension stroke ST by applying the control force Fc to cancel the pitch that occurs during the acceleration or the deceleration of the vehicle 1, and to generate the reverse pitch moment. Here, “canceling the pitch” refers to suppressing the generated pitch or generating the pitch in a direction opposite to the generated pitch as compared with a case where the pitch control is not executed.

In each wheel 2, the control force Fc that is the suspension stroke generation force is considered to be positive when the control force Fc acts to lift the sprung structure 5 upward. With this, each of the requested control amounts (roll requested control amount Xr and pitch requested control amount Xp) for the suspension stroke control is also considered to be positive when the requested control amounts act to lift the sprung structure 5 upward. Therefore, the roll requested control amount Xr is positive for the wheels 2 on the outside of the turning and is negative for the wheels 2 on the inside of the turning. Similarly, the pitch requested control amount Xp is negative for the right and left front wheels 2FR, 2FL and is positive for the right and left rear wheels 2RR, 2RL at the time of acceleration, and is positive for the front wheels 2FR, 2FL and is negative for the rear wheels 2RR, 2RL at the time of deceleration.

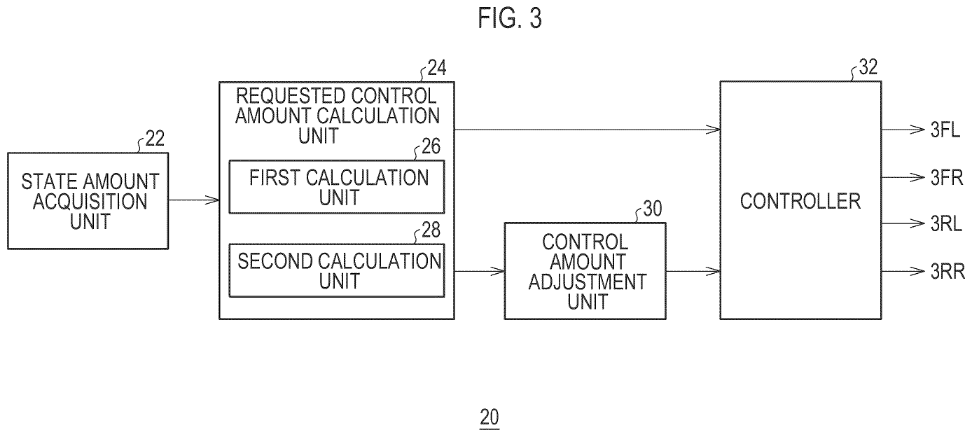

FIG. 3 shows a functional block of a vehicle suspension control system mounted on a vehicle. The suspension control system 20 includes the actuator 3A that controls the suspension stroke of the control target wheel and the ECU 10, and executes the posture control with respect to the vehicle operation input. The suspension control system 20 includes a state amount acquisition unit 22, a requested control amount calculation unit 24, a control amount adjustment unit 30, and a controller 32. The requested control amount calculation unit 24 includes a first calculation unit 26 configured to calculate a roll requested control amount for the roll control at the time of the turning accompanying the steering of the vehicle 1, and a second calculation unit 28 configured to calculate a pitch requested control amount for the pitch control accompanying the acceleration or the deceleration of the vehicle 1. The functional block shown in FIG. 3 is realized by the ECU 10.

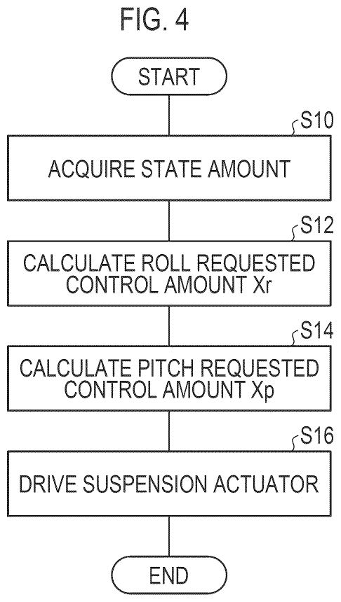

FIG. 4 shows an example of a flowchart for executing the posture control with respect to the vehicle operation input. The state amount acquisition unit 22 acquires the state amount of the vehicle 1 based on the sensor signal (measured value) provided from various sensors included in the sensors 12 (S10). In the embodiment, the state amount acquisition unit 22 acquires the state amount of the vehicle 1 needed to execute the posture control for the vehicle operation input. Specifically, the state amount acquisition unit 22 may acquire the lateral acceleration LA measured by the lateral acceleration sensor and the front-rear acceleration FA measured by the front-rear acceleration sensor at a predetermined cycle.

The first calculation unit 26 calculates the roll requested control amount Xr for the roll control (S12). The roll requested control amount Xr corresponds to a request value of the control force Fc requested for the roll control, and the calculation of the roll requested control amount Xr is performed for each of the wheels 2 on which the actuator 3A is disposed. The first calculation unit 26 may calculate the roll requested control amount Xr using, for example, the following Equation (1).

$$Xr = LA \times Gr \qquad ( 1 )$$

As shown in Equation (1), the roll requested control amount Xr is calculated by a product of the lateral acceleration LA and the roll gain Gr that is a control gain.

With the roll requested control amount Xr calculated by Equation (1), as the absolute value of the lateral acceleration LA increases, the absolute value of the roll requested control amount Xr also increases. The roll gain Gr may be a fixed value decided in advance. The lateral acceleration LA may be acquired as a measured value of a lateral acceleration sensor as described above, but may be acquired by being estimated based on information such as a vehicle speed and a steering angle.

The second calculation unit 28 calculates the pitch requested control amount Xp for the pitch control (S14). The pitch requested control amount Xp corresponds to a request value of the control force Fc requested for the pitch control, and the calculation of the pitch requested control amount Xp is performed for each of the wheels 2 on which the actuator 3A is disposed. The second calculation unit 28 may calculate the pitch requested control amount Xp using, for example, the following Equation (2).

$$Xp = FA \times Gp \qquad ( 2 )$$

As shown in Equation (2), the pitch requested control amount Xp is calculated by a product of the front-rear acceleration FA and the pitch gain Gp that is a control gain.

With the pitch requested control amount Xp calculated by Equation (2), as the absolute value of the front-rear acceleration FA increases, the absolute value of the pitch requested control amount Xp also increases. The pitch gain Gp may be a fixed value decided in advance. The front-rear acceleration FA may be acquired as a measured value of a front-rear acceleration sensor as described above, but may be acquired by being estimated based on request information of a vehicle front-rear force (for example, a request engine torque or a request braking force). It is preferable that the pitch gain Gpa used for calculating the pitch requested control amount Xp at the time of acceleration is set to be smaller than the pitch gain Gpd used for calculating the pitch requested control amount Xp at the time of deceleration.

When the vehicle behavior at the time of deceleration and the vehicle behavior at the time of acceleration is compared, a larger jerk or G is generated at the time of deceleration. Therefore, the pitch gain Gpa used for calculating the pitch requested control amount Xp at the time of acceleration may be set to be smaller than the pitch gain Gpd used for calculating the pitch requested control amount Xp at the time of deceleration. For example, when the pitch gain Gpd at the time of deceleration is set to 1, the pitch gain Gpa at the time of acceleration may be set to 0.5.

The suspension control system 20 according to the embodiment executes the roll control and the pitch control at the same time. Therefore, by setting the pitch gain Gpa at the time of acceleration to be small, even in a case where the roll requested control amount Xr is large at the time of acceleration, the possibility of generating the control force Fc needed for the posture control within the range of the capability of the actuator 3A is increased. In addition, even in a case where the roll control is not executed and solely the pitch control is executed, since a larger jerk or G is generated at the time of deceleration, it is possible to set the pitch gain Gpa at the time of acceleration to be smaller than the pitch gain Gpd at the time of deceleration.

The controller 32 executes processing of instructing the actuator 3A with the requested control amount X that is a sum of the roll requested control amount Xr and the pitch requested control amount Xp for each of the wheels 2 to drive each of the actuators 3A (S16). Therefore, each of the actuators 3A is controlled to generate the control force Fc according to the instructed requested control amount X.

The relationship between the roll gain Gr used for calculating the roll requested control amount Xr and the pitch gain Gp used for calculating the pitch requested control amount Xp will be considered. In general, since the tread is smaller than the wheel base, when the same control force Fc (suspension stroke) is generated, the roll control can create a larger vehicle posture angle than the pitch control, and the degree of reduction in the body G with respect to the actual G is increased. That is, by increasing the roll requested control amount Xr in the total requested control amount X, the total body G can be reduced. Therefore, the first calculation unit 26 is preferably configured to calculate the roll requested control amount Xr using the roll gain Gr larger than the pitch gain Gp used by the second calculation unit 28 to calculate the pitch requested control amount Xp. For example, when the pitch gain Gp is set to 1, the roll gain Gr may be set to 1.5. As described above, by setting the roll gain Gr to be larger than the pitch gain Gp, it is possible to effectively reduce the total body G.

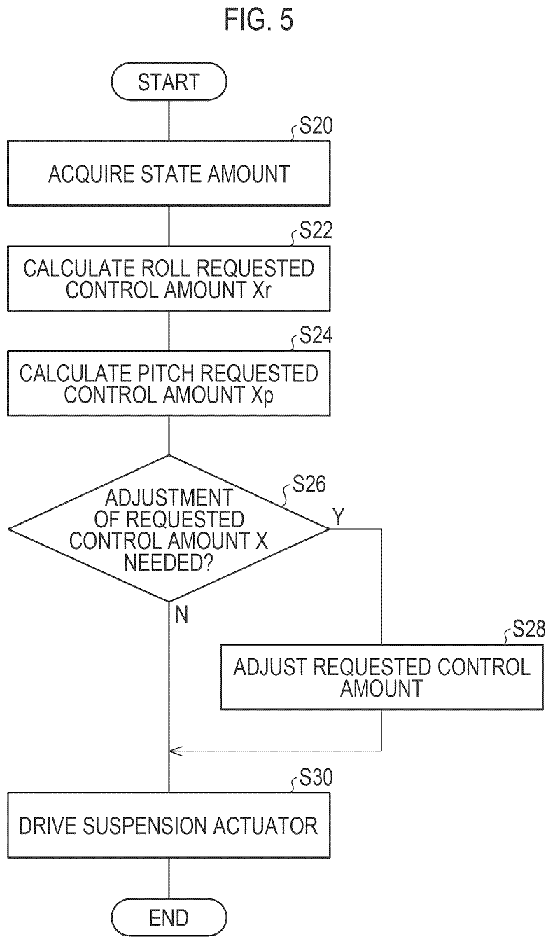

FIG. 5 shows another example of the flowchart for executing the posture control with respect to the vehicle operation input. The state amount acquisition unit 22 acquires the state amount of the vehicle 1 based on the sensor signal (measured value) provided from various sensors included in the sensors 12 (S20). In the embodiment, the state amount acquisition unit 22 may acquire the lateral acceleration LA and the front-rear acceleration FA at a predetermined cycle as the state amount of the vehicle 1 needed to execute the posture control for the vehicle operation input.

The first calculation unit 26 calculates the roll requested control amount Xr for the roll control using Equation (1) (S22), and the second calculation unit 28 calculates the pitch requested control amount Xp for the pitch control using Equation (2) (S24). The control amount adjustment unit 30 determines whether the adjustment of the total requested control amount X that is a sum of the roll requested control amount Xr and the pitch requested control amount Xp is needed (S26).

Specifically, the control amount adjustment unit 30 determines whether the total requested control amount X for the actuator 3A is close to a predetermined upper limit value or exceeds the predetermined upper limit value. The requested control amount X being close to the predetermined upper limit value may indicate that the requested control amount X is equal to or greater than Y % of the predetermined upper limit value, where Y may take a value of 90 or more and 100 or less.

The predetermined upper limit value may be a capability limit value determined by the capability (specification) of the actuator 3A, or may be an upper limit value set in the posture control. In addition to the posture control with respect to the vehicle operation input in the embodiment, the posture control (ride comfort control) with respect to the road surface input may be performed. In this case, the total requested control amount X for the actuator 3A may be calculated as a total value of the requested control amounts in all the posture controls.

There is a case where the adjustment of the requested control amount X is not needed, that is, a case where the requested control amount X is less than Y % of the predetermined upper limit value (N in S26). In this case, the controller 32 executes the processing of instructing the actuator 3A with the requested control amount X that is a sum of the roll requested control amount Xr and the pitch requested control amount Xp for each of the wheels 2 to drive each of the actuators 3A (S30). Therefore, each of the actuators 3A is controlled to generate the control force Fc according to the instructed requested control amount X.

On the other hand, in a case where the adjustment of the requested control amount X is needed, that is, in a case where the requested control amount X is equal to or greater than Y % of the predetermined upper limit value (Y in S26), the control amount adjustment unit 30 adjusts the requested control amount X to reduce the requested control amount X (S28). As described above, the larger the roll requested control amount Xr in the total requested control amount X, the more the total body G can be reduced. Therefore, the control amount adjustment unit 30 adjusts the requested control amount X by reducing the pitch requested control amount Xp without changing the roll requested control amount Xr. Specifically, the control amount adjustment unit 30 may reduce the pitch requested control amount Xp by setting the pitch gain Gp used for calculating the pitch requested control amount Xp to be small.

When the adjustment of the requested control amount X is needed, the control amount adjustment unit 30 may set the pitch gain Gp to be smaller as the roll requested control amount Xr is larger.

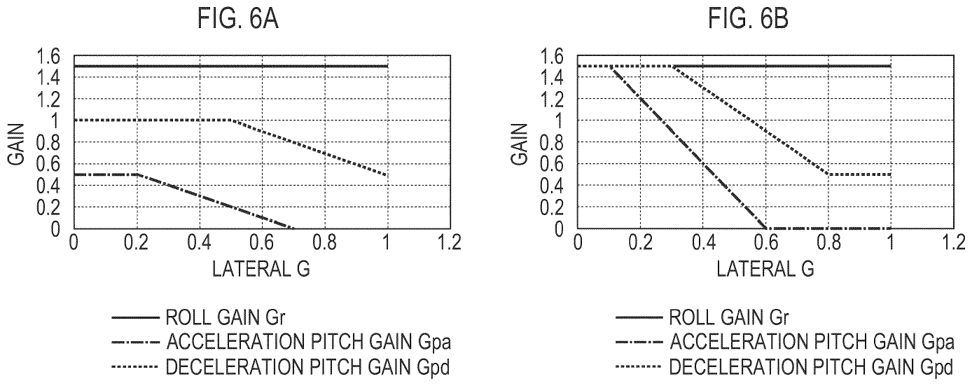

FIG. 6A shows an example of a relationship between the roll gain Gr and the pitch gain Gp. The horizontal axis indicates the lateral acceleration. In the example shown in FIG. 6A, regardless of the magnitude of the lateral acceleration, the magnitude of each of the control gains is set such that a relationship of
Gr>GPa>Gpd
   is satisfied, and is set such that the acceleration pitch gain GPa and the deceleration pitch gain Gpd are set to be smaller as the roll requested control amount Xr increases.

FIG. 6B shows another example of the relationship between the roll gain Gr and the pitch gain Gp. The horizontal axis indicates the lateral acceleration. In the example shown in FIG. 6B, when the roll requested control amount Xr proportional to the lateral acceleration is small, the magnitude of each of the control gains is set to be the same. As the roll requested control amount Xr increases, both the acceleration pitch gain GPa and the deceleration pitch gain Gpd are set to decrease, but the acceleration pitch gain GPa may be decreased at a larger reduction rate than the deceleration pitch gain Gpd.

The disclosure has been described above based on the embodiments. It should be noted that the embodiments are merely an example, and it is understood by those skilled in the art that various modifications can be made to the combination of the components and processes thereof, and that such modifications are also within the scope of the disclosure.

What is claimed is:

1. A vehicle suspension control system comprising:
an actuator configured to control a suspension stroke of a control target wheel; and
an electronic control unit, wherein:
the electronic control unit includes a requested control amount calculation unit configured to calculate a pitch requested control amount for pitch control; and
a pitch gain used for calculating a pitch requested control amount at a time of acceleration is set to be smaller than a pitch gain used for calculating a pitch requested control amount at a time of deceleration.

2. The vehicle suspension control system according to claim 1, wherein:
the requested control amount calculation unit includes
a first calculation unit configured to calculate a roll requested control amount for roll control, and
a second calculation unit configured to calculate the pitch requested control amount for the pitch control; and
the first calculation unit is configured to calculate the roll requested control amount using a roll gain larger than the pitch gain that is used by the second calculation unit for calculating the pitch requested control amount.

3. The vehicle suspension control system according to claim 2, further comprising a control amount adjustment unit configured to restrict the pitch requested control amount to be small in a case where a total requested control amount for the actuator is close to or exceeds a predetermined upper limit value.

4. The vehicle suspension control system according to claim 3, wherein the control amount adjustment unit is configured to restrict the pitch requested control amount to be small by setting the pitch gain used for calculating the pitch requested control amount to be small.
